(19) United States
(12) Patent Application Publication
(10) Pub. No.: US 2019/0005543 A1
(43) Pub. Date: Jan. 3, 2019

(54) EMBEDDED PORTALS FOR NETWORKED MATCHING AND PROCUREMENT

(71) Applicant: BRINGHUB, INC, Los Angeles, CA (US)

(72) Inventors: Albert KHASKY, Los Angeles, CA (US); Dominik PANTELIDES, Los Angeles, CA (US); John ADAMS, St. Petersburg, FL (US)

(21) Appl. No.: 16/124,186

(22) Filed: Sep. 6, 2018

Related U.S. Application Data
(63) Continuation of application No. PCT/US17/21165, filed on Mar. 7, 2017.
(60) Provisional application No. 62/304,699, filed on Mar. 7, 2016.

(51) Int. Cl. G06Q 30/02; G06Q 30/06; G06F 17/30; H04L 29/06

(52) U.S. Cl. CPC G06Q 30/0263; G06Q 30/0633; G06F 17/30946; H04L 67/20; G06F 17/30882; G06F 17/30896; H04L 63/166

(57) ABSTRACT

Systems and methods here relate to using computers including computer servers in communication with a network to, receive data describing items from third party servers, create a table of correlated text and images for each of the items for which data was received, retrieve content posted on a target website over the network, analyze text in the posted content, analyze images in the posted content, match the analyzed text and images with an item from the table of correlated items, embed a link in the posted content, the link corresponding to the analyzed text and images that matched the item. In some examples, the link may be selected by a user to add the item corresponding to the link to an agnostic receptacle.

### CROSS REFERENCE TO RELATED CASES

This application claims the benefit under 35 USC 120 as continuation of International Patent Application No. PCT/US2017/21165, filed Mar. 7, 2017, and titled “EMBEDDED PORTALS FOR NETWORKED MATCHING AND PROCUREMENT” and relates to and claims priority of the U.S. provisional application 62/304,699 filed 7 Mar. 2016, and titled “EMBEDDED PORTALS FOR NETWORKED MATCHING AND PROCUREMENT”, the entirety of which is hereby incorporated by reference.

### TECHNICAL FIELD

This application relates to scanning, analyzing and extrapolating content from websites. In some examples, the analysis includes lexical analysis, additionally or alternatively, the analysis includes image analysis.

### BACKGROUND

Many websites and blogs in existence today are content-centric. They provide their readers with unique video, images, and text relating to a multitude of subject matter and are often the point of discovery for products and services. One of the ways these content publishers generate revenue is to redirect their readers to retail websites. In exchange for doing so, should a purchase take place, the publisher earns a commission.

Many issues can arise as a result of that redirection. In fact the average conversion rate for these purchases is less than 1%. Often, when a publisher redirects a reader to a retail website it is to a specific product page. And because the publisher website is not aware of if the product has sold out or has been discontinued, readers often find themselves at a dead end. Worse, those links are rarely updated and will continue to send users to pages where they cannot purchase the desired item. Furthermore, reader attrition to third party retail websites can result in decreased traffic and therefore might reduce revenue potential for content publishers.

From an aesthetic standpoint, content sites tend to be highly stylized, doing a far better job than retail websites to entice readers to purchase. Images and descriptions are often quite distinct and of higher quality than what is included on the retail sites for a given product or product grouping. For example, a publisher might make use of a picture wherein a celebrity or public figure can be seen with a product. Yet on the retail site, the images are generic. Therefore, upon redirecting a reader, that intention to buy can vanish as curated content is no longer present.

Another undesirable byproduct of the redirection is that readers often find themselves having to visit several different retail sites if they'd like to purchase all of the products listed on a single piece of publisher content. Additionally, they have to provide all of the information required to purchase a product multiple times (for each individual retailer from which they're purchasing a product).

Lastly, from a technical standpoint, in order to ensure that publishers earn a commission for referral sales, they cannot simply include the link for a given product or store, but instead have to generate a special link that facilitates a tracking capability. These links may be known as “affiliate links.” In order to generate affiliate links, publishers often are forced to create them by hand for each product they would like to feature. This is problematic for a number of reasons. Foremost, the process to generate these links are specific for each site. As such, publishers must keep track of the different software required to generate them. This means every contributor for a given publisher site must be cognizant of all the various methods by which the links are generated. If a publisher makes any mistakes or simply forgets to generate the appropriate affiliate link, they might lose credit for a sale, or publish a broken link.

As a publisher's site grows, the likelihood of keeping links to old offers up-to-date decreases due to the volume of historical content on the site. The content surrounding these links is also likely to become stale, due to the disconnect between the publisher and the site the offer resides on. In some cases the links provided can become invalid and directly impact the user experience, and can also cause traffic to be sent to un-optimized links that are no longer relevant to the content which can produce error pages, links to old data, links to discontinued products, etc. Therefore, technical solutions are needed to address these technical problems.

### SUMMARY

Systems and methods here relate to using computers including computer servers in communication with a network to facilitate directing computer traffic. In some examples, a server with a processor and memory in communication with a network, is used for receiving data describing items from third party servers, creating a table of correlated data for each of the items for which data was received, retrieving content posted on a target website over the network, analyzing the posted content, matching the analyzed content with an item from the table of correlated items, embedding a link in the posted content, the link corresponding to the analyzed content that matched the item. In some examples, the link may be selected by a user to add the item corresponding to the link to an agnostic receptacle. In some examples, the analysis of the text and the analysis of the images is governed by content scanning rules delivered in a payload specific to the target website. In some examples, the rules are used by the server to identify specific HTML meta tags, cascading style sheets (CSS) selectors to calculate keyword density in the content of the target website. In some examples, the rules are used to determine a URL whitelist and blacklist for both the webpage and links contained within the webpage. In some examples, the system is used to create a data model based on the keyword density. In some examples, further comprising, by the server, apply a matching algorithm to the data model. In some examples the data model is encrypted using transport layer security (TLS).

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a network diagram according to certain embodiments disclosed here.

FIG. 2 is a network flow chart diagram according to certain embodiments disclosed here.

FIG. 3 is a flow chart according to certain embodiments disclosed here.

FIG. 4 is a screenshot of a graphical user interface GUI according to certain embodiments disclosed here.

FIG. 5 is a hardware diagram showing computer components which may be used to practice certain embodiments disclosed here.

### DETAILED DESCRIPTION

Reference will now be made in detail to embodiments, examples of which are illustrated in the accompanying drawings. In the following detailed description, numerous specific details are set forth in order to provide a sufficient understanding of the subject matter presented herein. But it will be apparent to one of ordinary skill in the art that the subject matter may be practiced without these specific details. Moreover, the particular embodiments described herein are provided by way of example and should not be used to limit the scope of the invention to these particular embodiments. In other instances, well-known data structures, timing protocols, software operations, procedures, and components have not been described in detail so as not to unnecessarily obscure aspects of the embodiments of the invention.

Overview

The systems and methods here, including a platform for networked sales was created to address each of the technical issues listed above by facilitating an in-content experience. That means publishers no longer have to redirect their readers off site to purchase products and services that are part of their content, all while still earning the commissions as they did in the previous affiliate link model. Instead, embedded links within articles that are not otherwise storefronts, may direct users to purchase the same or similar products in a pop up or other style interface. These purchasing interfaces may pull products from multiple sources but consolidate them into a user perceived unitary front.

Because the system's agnostic receptacle can be programmed to be aware of inventory levels and therefore may preclude the need for redirection to retailers, reader users are never sent directly to third-party sites or redirected to them where the desired product may not be available. Instead, if the same or similar product is offered for sale by a different retailer, the reader can be given the option to purchase that product instead. In some examples, the agnostic receptacle can be considered an online shopping cart.

In some examples, the system agnostic receptacle can be styled and branded to match the look and feel of any publisher website. In doing so, the receptacle experience may appear consistent with the content consuming experience. Readers may, for example, be presented with a shopping cart that looks and feels as though the publisher of the content created it, resulting in potential increased conversion rate.

In some examples, the system platform can be used to manage affiliates on behalf of publishers. Such features may allow content publishers to create content and reference items without having to address affiliate logistics. Instead, the system platform takes on this task and chooses the appropriate affiliate based on a given publisher's specific rules and settings.

In some examples, the system shopping cart can also alleviate the need to visit several different retail sites by allowing readers to purchase goods and services offered by multiple retailers at the same time from within the system shopping cart. Thus, many multiple shopping experiences can be aggregated into one cart and one check out experience.

Network Examples

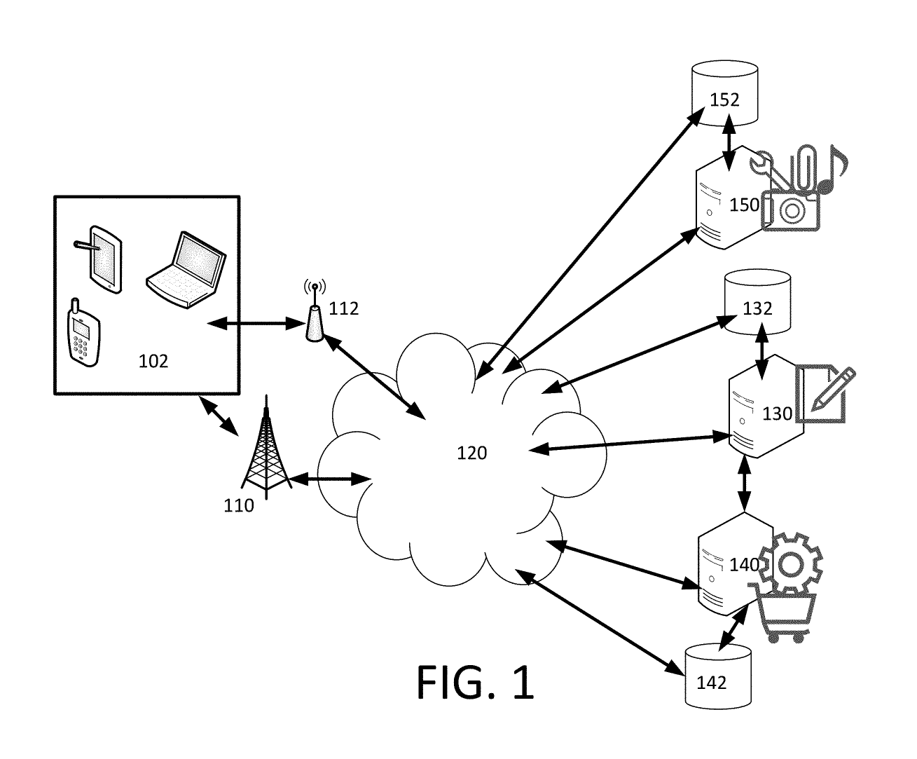

FIG. 1 is a network diagram showing an example setup of the systems described herein. In FIG. 1, the various devices 102 are used by users to access various networked webpages. The user devices 102 could be any kind of computing device such as but not limited to a laptop, tablet, mobile, smartphone, wearable such as watch or glasses. Through these user devices 102, the users may wired, or wirelessly such as cellular 110 or WiFi 112 connect to the internet 120 and thereby to any respective back end servers 130 which host various web content. Wireless connections could be any wireless connection such as but not limited to cellular such as 3G, 4G LTE, 5G, WiFi, Near Field Communication, Bluetooth Low Energy, pico cell, nano cell, infrared, or other.

The back end servers 130 which host the content may include databases 132 which are used to store the underlying data which may be accessed and/or displayed via the internet 120 or other network. It should be noted that the underlying hosted content could be any kind of content, including but not limited to written articles, multimedia experiences such as music, video, music and video, augmented reality, virtual reality, or other content including a combination of any of the above or other content.

The servers 140 which host the checkout and sales capabilities described here may be in communication with the various servers 130 that host the underlying web content. These servers 140 may also have their own storage 142. Through the access of the web hosting servers 130, either directly or through the internet 120, the systems 140 are able to retrieve content, for example, from the web publication article, and coordinate sales of the underlying items from third party sales websites hosted on still other servers 150 with their own data storage 152. The servers 140 may host the engines to match content from the online publications 130 with items to sell 150 as described herein.

Auto-Content Recognition Engine

In certain example embodiments, the system may utilize an auto-content item recognition engine to discover items referenced inside of publisher websites to make them available for users. The engine may identify items through a scan and then map generic and/or custom content metadata to shop-able item groupings (collections). The engine may gather relevant data by means of lexical analysis, device fingerprinting, image and video analysis, and using any combination of these features to analyze the content of a website.

Content scanning rules may be delivered in a payload that is specific to the page and/or section of the page that initiated the server request. These rules are able to identify specific HTML meta tags, cascading style sheets (CSS) selectors to calculate keyword density from, as well as URL whitelist/blacklist functionality for both the page and links contained within the page. The below configuration would only scan links not matching the elements in the link_blacklist found within the scan_section. The keyword density map would be calculated by the text found in the keyword_section.

```
{
  pageId:“1234567910”,
  scan_section:“.article”,
  keyword_section: “.article > p”,
  whitelist: [“/section1/”,“/section2/page2”],
  blacklist: [“/section1/page3”],
  link_blacklist: [“www.retailer-to-skip.com”]
}
```

### Example Scanning Configuration

Once the data model has been created, it is sent to the server application programming interface (API) to have the item matching algorithm applied to it. In order to account for security this is done via a Post Message API found in web browsers to ensure the messages come from a secured iFrame that is white listed to connect to the server API. These communications are encrypted using transport layer security (TLS) based encryption.

```
{
  page_url:“https://example-publisher.com/section1/page1”,
  title:“Page 1”,
  description:“This page contains products”,
  image:“https://example.com/images/page1.jpg”,
  links:[“https://example.com/1”,“https://example.com/2”,...],
  keywords: [{k:“fancy”,v:1123}, {k:“hats”,v:81},...],
  user: {
  user_agent: “chrome v10 windows x64...”,
  language: “en-us”,
  geometry: { sw: 1024, sh: 768, m_x: 100, m_y: 1002, ...}
  }
}
```

### Example Data Model

Client Examples

In certain example embodiments, there are three components to automatic content product recognition. The client which is used to gather the data, the algorithm that cross references the gathered data with retail platforms, and the servers/databases where the associations discovered by the algorithm are stored.

In certain examples, the client component is what online publishers include on their websites in order to enable the system shopping cart experience. This client may be software that the online publisher uses after they have created some online content that includes items which users may be attracted to. The software may gather data from within a given web-page by scanning the content and capturing the metadata that is associated and/or relevant to products and services listed therein.

It may also do the work of gathering certain data to be passed along to the System backend for analysis as explained herein.

Such clients can be configured to behave differently on a per publisher basis, whereby rules are created to determine what metadata to ignore versus what metadata is to be passed along for analysis. The client may also pass references to images, videos, and or any other assets present in the page.

Lexical Analysis Examples

In certain examples, lexical analysis may include text recognition software that is able to read the text on the published website and identify text which matches up with a database of product information. In such examples, the identified product or products is then linked to the text, so the system may offer it for purchase as described herein.

The lexical analysis component may be achieved by analyzing all of the text that is present in the web based content. That text may then be passed to servers on the back end of the platform, to be broken down into single words, sentences, and or phrases that can be individually analyzed. The analysis can then reveal if any words, phrases, and or sentences either directly or indirectly reference a product or service. Tables and/or maps may be used to pair up specific words to specific products or groups of products, which can then be presented for purchase.

An example of a direct reference could be a specific product name, whereas an indirect reference might not be tied to a specific product or service but a genre or grouping of products. In either case, depending on the individual publisher's preference, both specific and indirect product references can be tied to products and therefore be used to initiate the shopping cart experience.

Image Analysis Examples

In certain examples, image analysis may include image recognition software that is able to analyze an image on the published website and identify portions of the image which match up with a database of product information. In such examples, the identified product or products is then linked to the image, or otherwise correlated in the table so the system may offer it for purchase as described herein.

Images and video are ubiquitous in the context of content. Not only do they enhance the user's ability to engage the content, but are also a rich source of information that can be mined for seeking out products and services that may be directly and or peripherally related. As described, here the systems and methods may utilize an image analysis algorithm to quickly ascertain if a particular image is of a specific product. If an immediate match is not made, a deeper analysis may be performed whereby objects from within the images may be recognized which are then categorized to be cross-referenced with known products and or services.

In the case of videos, some of them contain meta-data that can be mined for product recognition. In addition, third party platforms may provide product information contained in the videos. These typically apply to movies and television productions where the third parties have already done the work of gathering the products and services that may be relevant to a specific video.

The engine may then use the collected data to cross-reference a database of products, services, and related data to curate a list of directly relevant products and those products that are peripherally related.

Matching Engine Algorithm

In certain example embodiments, the algorithm is called each time the client passes a payload for a given publisher page. If the algorithm has already encountered a similar payload and done the work of curating products, that data is returned. Otherwise, depending on the nature of the data returned by the client, the algorithm will utilize various methodologies to divide and analyze it.

In certain embodiments, to extrapolate data from video content, third parties technologies specializing in analyzing may be utilized. Such technologies are able to procure metadata from the given video content which can in turn be used to seek out relevant products and services.

Image references that the client returns are cross-referenced with known product images in an effort to find an exact match across System's entire product catalogue along with the internet at large. In some cases an exact match can be found while in other cases, a fuzzy match is returned. In either case, the algorithm tries to map the image with a product or service.

Keywords, and other contextual data are also passed along to the algorithm. These are cross-referenced against third party retail websites along with the internal tags, categories, and keywords that have already been associated with products within the System product catalogue.

If the algorithm is able to produce a listing of one or more relevant products for a given publisher page, those product lists are then stored as collections inside of the System platform on servers along with the pages from which that they were generated. It is this data that is returned to the client, in real time, corresponding to the publisher page from which it originated. Once that data has been fetched by the client, it embeds and/or overlays calls-to-action (shopping buttons) that trigger the System shopping cart.

Depending on the nature of the data returned by the client, the algorithm will utilize various methodologies to divide and analyze it. One methodology is to initiate a web request to the various URLs and extract and process the data to identify any actionable offers. An example of an offer extractor for a product page that has been processed into a JSON document would be:

```
function extract_product(document) {
  if(id = document.find(‘.retailer_id”)) {
  var product = { }
  product.id = id.text( );
  product.name = document.find(‘.name’).text( );
  product.price = document.find(‘.price’).map(function(p) {
    return {
      price: p.find(‘.current’).text( ),
      original: p.find(‘.old-price’).text( )
    }
  });
  product.categories = document.find(‘.breadcrumb’).map(
    function(b) {
      return b.text( );
    }
  );
  ...
  return product;
  }
  return;
}
```

### Example Offer Extractor

Upon finding any actionable offers, associations are created between the offers encountered and the metadata provided in the data model. This includes linking the offer to the page_url, the keywords (with a ranking based on the keyword density), as well as the images supplied in the payload. This allows the creation of a site specific graph representing all featured offers on a site, as well as their categorical information.

Device Fingerprinting Examples

Device fingerprinting used in conjunction with the lexical analysis described above can further enhance the ability to tie products and services that are not just relevant to the content, but to the specific user that is consuming that content. Knowing the type of computing device that a given user is on, such as the type of tablet and or mobile device, can be leveraged to cultivate a shopping experience that directly applies to the user's specific device such as platform specific applications, accessories, and services. For example, a tablet user may require specific peripherals for the device. And mobile users may be focused on applications that run on their device. Brands may be factored in as well, steering customers towards brands of products that they already utilize.

Example Orders

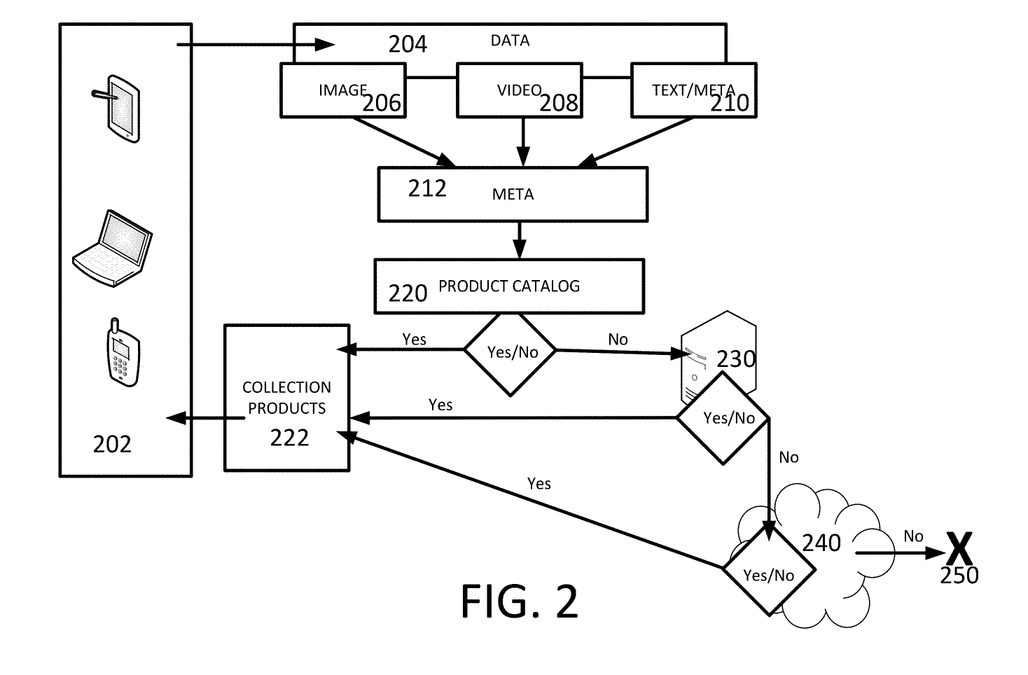

FIG. 2 is a network diagram flow chart showing example steps that the system may take in order to receive and process orders from a user.

In the example, the client 202 views the data 204 which is online content, hosted by a publisher. Within the online published content are three kinds of links which the user may utilize to select products. In this example, the links are in images 206, video 208 and/or text 210.

Next, for which ever kind of link the user selects, the metadata 212 from the link is sent to the product catalog 220 for matching. This is when the matching engine begins to match an actual offered product with the linked product in the online content.

In this example, the system first checks if the product catalog contains the same or similar products. If yes, then the items within the collection products 222 is indicated for the user to select and purchase. If not, the system them checks to see if the product is available on a third party website 230. If it is, the system then makes that item available in the collection products 222 is indicated for the user to select and purchase. If not, the system them checks the internet at large 240 to see if there are any products available anywhere which match or are similar to the selected product. If so, then the system makes that item available in the collection products 222 is indicated for the user to select and purchase. If not, then the system returns a negative result to the user 250.

In certain example embodiments, databases are used to store the associations discovered by the algorithm. In certain embodiments, servers may provide access and search/retrieve to these databases. The databases may be local or networked.

Embedded Link User Experience

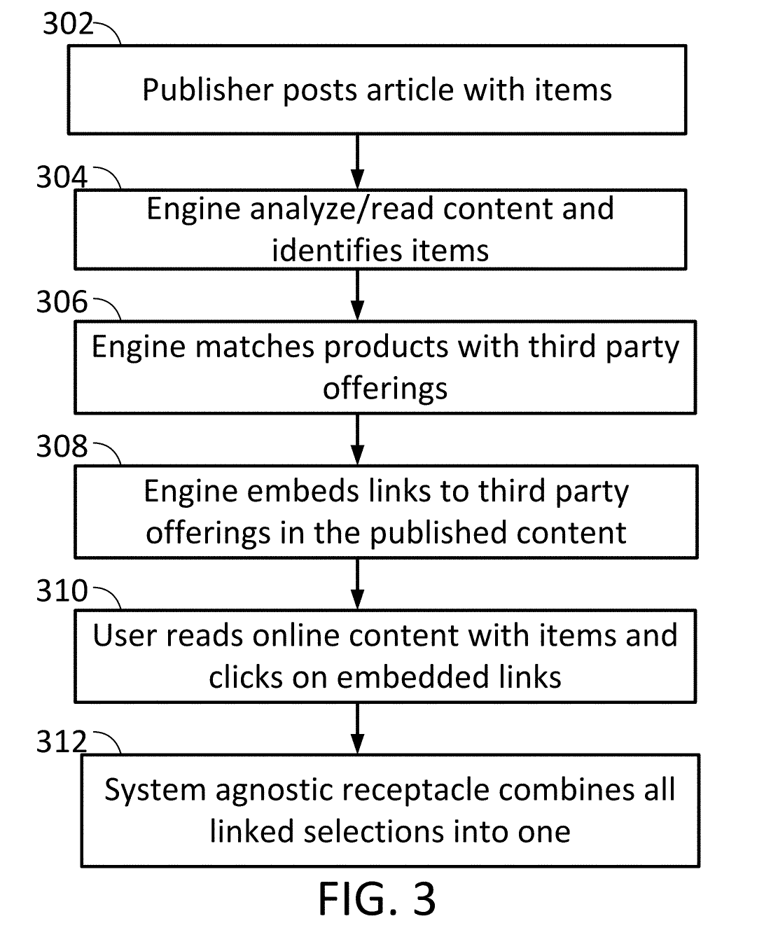

FIG. 3 is a flow chart showing an example process which the systems here may utilize. First, 302 the online publisher, for example a magazine article, posts online. The published content is directed toward a magazine article about hiking in the outdoors and features photos of hikers in the mountains and details certain trails that the author and photographer took. Within the article and photos, there are items either placed specifically, or through happenstance. A user reading the article may be intrigued by the gear that the photographer is using, or the hiking equipment the hikers are enjoying. The systems next analyze/read the content 304 by analyzing the text and/or the images in the article to identify items. Next, the engine 306 matches the items it identifies with third party offerings. In some examples this is an offering of the sale of those or similar products. Then, the engine embeds links to the third party offerings 308 within the online publication of content. This could be in the form of extra links or links under the text or links under the images. The user is then able to read the online content, see the items and click the embedded links 310. Finally, the system is able to combine all of the third party offerings into one coordinated agnostic receptacle 312 which the user may utilize without having to log in or visit many multiple pages. In some examples, the agnostic receptacle 312 is in the form of a shopping cart that may receive selections from multiple websites.

Example Consolidated Receptacle

In certain examples, the system is able to coordinate the checkout of the products which the user has selected from the embedded links within the online content. The system is able to do this by coordinating with the third party servers that offer the content before the user clicks the link. Then, when the user clicks the embedded link for a certain product, the system just loads the linked information for that product, for the user to view.

In some example embodiments, the system is able to display specific detailed information about the selected items that the user decides to put into her shopping cart, before purchasing. This detailed information may come from the third party servers that offered the items offered in the first place.

Finally, once selected, the user may utilize one checkout in order to pay for and enter shipment details for all of the products, no matter where they are actually sourced by the system. Therefore, with one checkout, the user may be purchasing products from multiple different online retailers, but because the system is able to coordinate the purchase, payment and shipment details, the user sees only one unified shopping cart and checkout experience. In other words, the receptacle is agnostic as to the source itself, and may combine multiple sources into one resultant experience.

In certain examples, the actual orders are then sent to the third party product providers and the payments are divided appropriately. In such examples, the individual third party companies coordinate the shipments of the goods that the user purchased from them. Alternatively or additionally, in certain example embodiments, the shipments are all coordinated by a central system and/or combined for shipment.

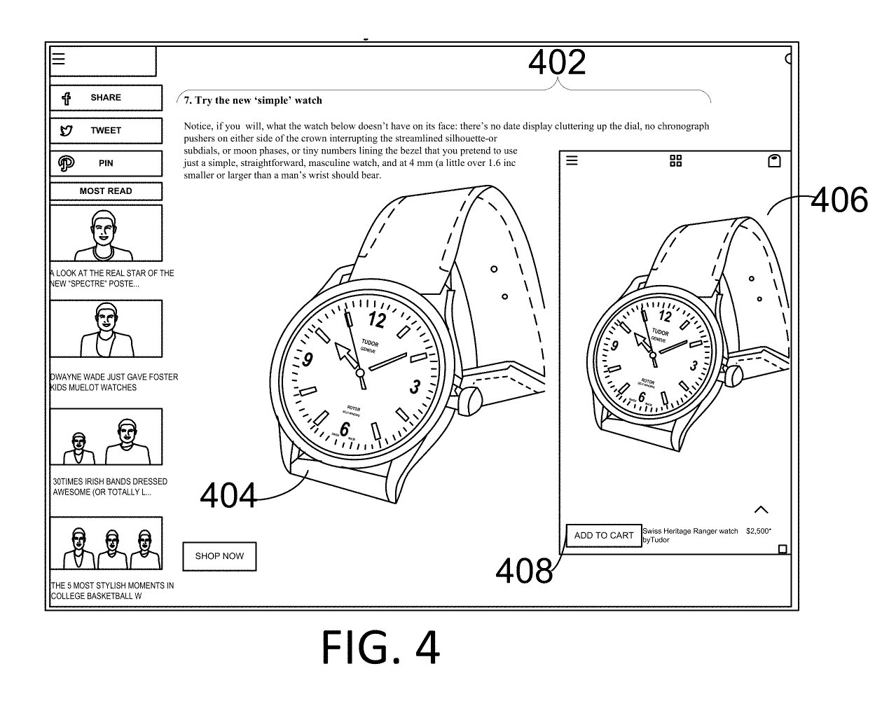

FIG. 4 is a screenshot of an example of a user interface which may be used to practice the systems and methods described here. In the example, a user is viewing online content in the form of an article 402. The article may appear in any website with any other various content that the website publisher might include in a content-driven website, which is not geared toward selling products. The example article text 402 includes a mention of a particular item, in this case a watch. Previously, without the innovations described here, if the user was interested in buying such an item, the user would navigate to a search engine and attempt to locate the same item at an online vendor using key words with inconsistent results.

In the example shown here, the user is instead able to click on an icon or hover a pointer over the picture 404 and a window 406 may be displayed within the article 402 itself. This is an example of the consolidated experience that can allow the user to view the offer 406 from a particular vendor which may or may not be apparent to the user, and click add to cart 408 as if they were on a dedicated shopping website. By clicking add to cart button 408, the user may add the same watch from the website article 402 to their online agnostic receptacle for checkout as described here. As described here, in some embodiments, the item offered for sale 406 may be the same or similar to that item 404 in the website article 402.

In some examples, the user can then navigate to another website which hosts different online content. And in this other website, the user may view content such as a different article hosted by that publisher, and repeat the purchasing experience for some other item in the second article and add that item to the same consolidated agnostic receptacle that they previously added the watch to 408. Thus, even if the first and second online publishers and even the online merchants are completely unrelated, the user can achieve a unified and consolidated experience all over the internet, through third party websites that are not even focused on shopping.

In this way, an online article discussing running may allow users to purchase the top five rated running shoes through a content-driven website. An article on healthcare could allow a user to purchase a blood sugar monitor while reading one doctor's opinion on its benefits. An online book about a fictional candy shop could allow a reader to purchase the described candy online while reading the book. The examples of integrated purchasing in content-driven websites could take any of these or other example forms.

Example System Configurations

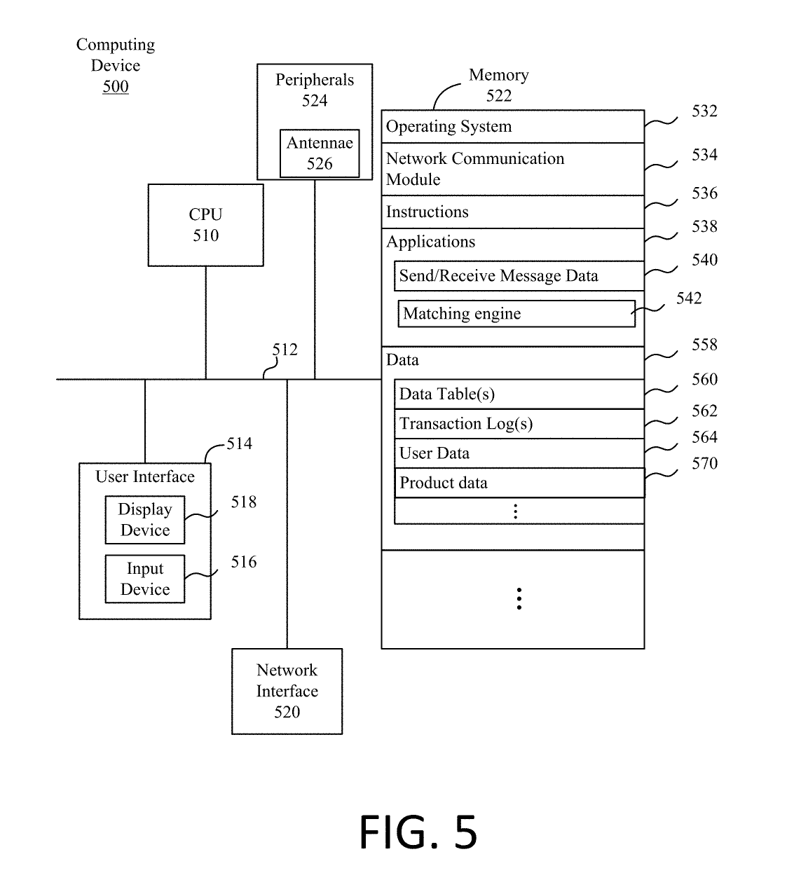

FIG. 5 is a computer hardware diagram showing an example device 500 which may be used to practice the embodiments described here. The example computing system 500 could be any number of servers located in a networked system or distributed system. In FIG. 5, a processor such as a central processing unit 510 may be arranged to communicate with a user interface 514 via a bus 512 or other communication path. The user interface may include a display device 518 such as a screen and a user input device 516 such as a keyboard, touch screen, mouse, pointer, gesture recognition, proximity sensor or other device. The computing device 500 may include a network interface 520 which may be used to interface with any kind of wired or wireless network such as WiFi or cellular and eventually the Internet and thereby other computing systems, data storage or user interfaces. Peripherals 524 may be included in the computing device 500 which may include an antenna 526 if the device is wireless capable.

Memory 522 may also be included in the computing device 500. The memory may include software instructions which the processor 510 may execute. The memory may include operating system 532 instructions, network communication modules 534, other instructions 536, applications such as sending and receiving messages 540 and a matching engine 542. Data 558 may be stored as well including but not limited to data tables 560, transaction logs 562, user data 564 and product data 570. Any computing device may be used to interface with users and vendors over a network.

### CONCLUSION

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

The innovations herein may be implemented via one or more components, systems, servers, appliances, other subcomponents, or distributed between such elements. When implemented as a system, such systems may include an/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the innovations herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the innovations herein may be achieved via or performed by logic and/or logic instructions including program modules, executed in association with such components or circuitry, for example. In general, program modules may include routines, programs, objects, components, data structures, etc. that performs particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

Innovative software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the present inventions may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

The software is stored in a machine readable medium that may take many forms, including but not limited to, a tangible storage medium, a carrier wave medium or physical transmission medium. Non-volatile storage media include, for example, optical or magnetic disks, such as any of the storage devices in any computer(s) or the like. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: disks (e.g., hard, floppy, flexible) or any other magnetic medium, a CD-ROM, DVD or DVD-ROM, any other optical medium, any other physical storage medium, a RAM, a PROM and EPROM, a FLASH-EPROM, any other memory chip, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

The present invention can be embodied in the form of methods and apparatus for practicing those methods. The present invention can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

The software is stored in a machine readable medium that may take many forms, including but not limited to, a tangible storage medium, a carrier wave medium or physical transmission medium. Non-volatile storage media include, for example, optical or magnetic disks, such as any of the storage devices in any computer(s) or the like. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: disks (e.g., hard, floppy, flexible) or any other magnetic medium, a CD-ROM, DVD or DVD-ROM, any other optical medium, any other physical storage medium, a RAM, a PROM and EPROM, a FLASH-EPROM, any other memory chip, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

What is claimed is:

1. A system, comprising:
a server with a processor and memory in communication with a network, the server configured to,
receive data describing items from third party servers;
create a table of correlated text and images for each of the items for which data was received;
retrieve content posted on a target website over the network;
analyze text in the posted content;
analyze images in the posted content;
match the analyzed text and images with an item from the table of correlated items;
embed a link in the posted content, the link corresponding to the analyzed text and images that matched the item,
wherein the link may be selected by a user to add the item corresponding to the link to an agnostic receptacle.

2. The system of claim 1 wherein the analysis of the text and the analysis of the images is governed by content scanning rules delivered in a payload specific to the target website.

3. The system of claim 2 wherein the rules are used by the server to identify specific HTML meta tags, cascading style sheets (CSS) selectors to calculate keyword density in the content of the target website.

4. The system of claim 2 wherein the rules are used to determine a URL whitelist and blacklist for both the webpage and links contained within the webpage.

5. The system of claim 3 further comprising, by the system, create a data model based on the keyword density.

6. The system of claim 5 further comprising, by the server, apply a matching algorithm to the data model.

7. The system of claim 6 wherein the data model is encrypted using transport layer security (TLS).

8. A method, comprising:
by a server with a processor and memory in communication with a network, the server,
receiving data describing items from third party servers;
creating a table of correlated data for each of the items for which data was received;
retrieving content posted on a target website over the network;
analyzing the posted content;
matching the analyzed content with an item from the table of correlated items;
embedding a link in the posted content, the link corresponding to the analyzed content that matched the item,
wherein the link may be selected by a user to add the item corresponding to the link to an agnostic receptacle.

9. The method of claim 8 wherein the analysis of the text and the analysis of the images is governed by content scanning rules delivered in a payload specific to the target website.

10. The method of claim 9 wherein the rules are used by the server to identify specific HTML meta tags, cascading style sheets (CSS) selectors to calculate keyword density in the content of the target website.

11. The method of claim 9 wherein the rules are used to determine a URL whitelist and blacklist for both the webpage and links contained within the webpage.

12. The method of claim 10 further comprising, by the system, create a data model based on the keyword density.

13. The method of claim 12 further comprising, by the server, apply a matching algorithm to the data model.

14. The method of claim 13 wherein the data model is encrypted using transport layer security (TLS).

15. The method of claim 8 wherein the content is text.

16. The method of claim 8 wherein the content is an image.

17. The method of claim 8 wherein the content is a video.

18. A non-transitory computer-readable medium having computer-executable instructions thereon for a method the method comprising:
by a server with a processor and memory in communication with a network, the server,
receiving data describing items from third party servers;
creating a table of correlated data for each of the items for which data was received;
retrieving content posted on a target website over the network;
analyzing at least one of text, an image or a video in the posted content;
matching the analyzed text, image or video with an item from the table of correlated items;
embedding a link in the posted content, the link corresponding to the analyzed text and images that matched the item.

19. The non-transitory computer readable medium of claim 18 wherein the link may be selected by a user to add the item corresponding to the link to an agnostic receptacle.

20. The non-transitory computer readable medium of claim 18 wherein the analysis of the text and the analysis of the images is governed by content scanning rules delivered in a payload specific to the target website.
